(19) United States
(12) Patent Application Publication
(10) Pub. No.: US 2016/0156028 A1
(43) Pub. Date: Jun. 2, 2016

(54) POSITIVE ACTIVE MATERIAL, LITHIUM BATTERIES INCLUDING THE POSITIVE ACTIVE MATERIAL, AND METHOD OF PREPARING THE POSITIVE ACTIVE MATERIAL

(71) Applicant: SAMSUNG SDI CO., LTD., Yongin-si (KR)

(72) Inventors: Hyunjoo JE, Yongin-si (KR); Jihyun KIM, Yongin-si (KR); Changwook KIM, Yongin-si (KR); Yongchan YOU, Yongin-si (KR)

(21) Appl. No.: 14/739,124

(22) Filed: Jun. 15, 2015

(30) Foreign Application Priority Data
Nov. 27, 2014 (KR) 10-2014-0167810

(51) Int. Cl. H01M 4/36; H01M 4/58; H01M 4/505; H01M 4/525; H01M 4/136; H01M 4/131

(52) U.S. Cl. CPC H01M 4/366; H01M 4/136; H01M 4/131; H01M 4/505; H01M 4/525; H01M 4/5825; H01M 2004/028

(57) ABSTRACT

Provided are a positive active material, lithium batteries including the positive active material, and a method of preparing the positive active material. The positive electrode active material, includes a core including a compound capable of reversibly performing intercalation or deintercalation of lithium ions; and a coating layer including an inorganic material adhered to at least a portion of a surface of the core, the inorganic material having an apatite structure.

### CROSS-REFERENCE TO RELATED APPLICATION

Korean Patent Application No. 10-2014-0167810, filed on Nov. 27, 2014, in the Korean Intellectual Property Office, and entitled: “Positive Active Material, Lithium Batteries Including the Positive Active Material, and Method of Preparing the Positive Active Material,” is incorporated by reference herein in its entirety.

### BACKGROUND

One or more exemplary embodiments relate to positive active material, lithium batteries including the positive active material, and a method of preparing the positive active material.

### SUMMARY

Embodiments may be realized by providing a positive electrode active material, including a core including a compound capable of reversibly performing intercalation or deintercalation of lithium ions; and a coating layer including an inorganic material adhered to at least a portion of a surface of the core, the inorganic material having an apatite structure.

The inorganic material having the apatite structure may be represented by the following Formula 1:

Me₁₀(PO₄)₆X₂ [Formula 1]

where Me is calcium (Ca), barium (Ba), or strontium (Sr); and X is a hydroxyl group (—OH), F, or Cl.

The inorganic material having the apatite structure may include one or more of calcium hydroxyapatite (Ca₁₀(PO₄)₆(OH)₂), barium hydroxyapatite (Ba₁₀(PO₄)₆(OH)₂), strontium hydroxyapatite (Sr₁₀(PO₄)₆(OH)₂), calcium fluoroapatite (Ca₁₀(PO₄)₆F₂), barium fluoroapatite (Ba₁₀(PO₄)₆F₂), strontium fluoroapatite (Sr₁₀(PO₄)₆F₂), calcium chloroapatite (Ca₁₀(PO₄)₆Cl₂), barium chloroapatite (Ba₁₀(PO₄)₆Cl₂), or strontium chloroapatite (Sr₁₀(PO₄)₆Cl₂).

The inorganic material having the apatite structure may be adhered to the surface of the core in a layered form or an island form.

The coating layer further may include lithium.

The positive electrode active material may include about 90% by weight to about 99.99% by weight of the core and about 0.01% by weight to about 10% by weight of the inorganic material having the apatite structure.

The positive electrode active material may include about 95% by weight to about 99.9% by weight of the core and about 0.01% by weight to about 5% by weight of the inorganic material having the apatite structure.

The core may include one or more of LiCoO₂, LiNiO₂, LiMnO₂, LiMn₂O₄, Li(NiₐCo_{b}Al_{c})O₂, Li(NiₐCo_{b}Mn_{c})O₂ (where 0<a<1, 0<b<1, 0<c<1, and a+b+c=1), LiNi_{1-Y}Co_{Y}O₂, LiCo_{1-Y}Mn_{Y}O₂, LiNi_{1-Y}Mn_{Y}O₂ (where 0≦Y≦1), Li(NiₐCO_{b}Mn_{c})O₄ (where 0<a<2, 0<b<2, 0<c<2, and a+b+c=2), Li[LiₐNi_{b}Co_{c}Mn_{d}M_{f}]O₂₋ₓFₓ (where M is one or more of Ti, V, Al, Mg, Cr, Fe, Zr, Re, Al, B, Ge, Ru, Sn, Nb, Mo, or Pt; a+b+c+d+f=1; 0<a<1, 0<b<1, 0<c<1, 0<d<1, and 0<f<1; and 0≦x<0.1), LiMn_{2-z}Ni_{z}O₄, LiMn_{2-z}Co_{z}O₄ (where 0<Z<2), LiCoPO₄, LiFePO₄, V₂O₅, TiS, or MoS.

Embodiments may be realized by providing a lithium battery, including a positive electrode including the presently disclosed positive electrode active material; a negative electrode opposite of the positive electrode; and an electrolyte between the positive electrode and the negative electrode.

The lithium battery may be operated in a voltage range of about 4.3 V to about 4.6 V.

Embodiments may be realized by providing a method of preparing a positive electrode active material, the method including mixing an inorganic material having an apatite structure with an organic solvent to prepare a coating solution; applying the coating solution to a surface of a core, the core including a compound capable of reversibly performing intercalation or deintercalation of lithium ions; and heat-treating the core to which the coating solution is applied.

The inorganic material having the apatite structure may be represented by the following Formula 1:

Me₁₀(PO₄)₆X₂ [Formula 1]

where Me is calcium (Ca), barium (Ba), or strontium (Sr); and X is a hydroxyl group (—OH), F, or Cl.

Heat-treating the core to which the ceramic compound is applied may be performed at a temperature of about 600° C. to about 1,000° C. for about 3 hours to about 10 hours.

### BRIEF DESCRIPTION OF THE DRAWINGS

Features will become apparent to those of skill in the art by describing in detail exemplary embodiments with reference to the attached drawings in which:

FIG. 1 illustrates a schematic diagram of a rough structure of a lithium battery according to one or more exemplary embodiments;

FIG. 2 illustrates X-ray diffraction (XRD) analysis results obtained before and after coating Ca₁₀(PO₄)₆(OH)₂ on a positive electrode active material prepared in Example 1;

FIG. 3 illustrates XRD analysis results obtained before and after calcining Ca₁₀(PO₄)₆(OH)₂ at about 950° C. to check whether the phase of Ca₁₀(PO₄)₆(OH)₂ is maintained even after calcining the coating material Ca₁₀(PO₄)₆(OH)₂ used in Example 1;

FIG. 4 illustrates capacity retention ratio (CRR) measuring results of lithium batteries of Example 4 and Comparative Example 1;

FIG. 5 illustrates results obtained by measuring initial efficiencies of lithium batteries manufactured in Examples 1 to 6 and Comparative Example 1 and measuring capacity retention ratios (CRRs) after 50 cycles of the lithium batteries;

FIG. 6 illustrates X-ray diffraction (XRD) analysis results obtained before and after applying Ca₁₀(PO₄)₆F₂ to a positive electrode active material prepared in Example 7;

FIG. 7 illustrates XRD analysis results obtained after calcining Ca₁₀(PO₄)₆F₂ at about 950° C. to check whether the phase of Ca₁₀(PO₄)₆F₂ is maintained even after calcining the coating material Ca₁₀(PO₄)₆F₂ used in Example 7;

FIGS. 8 to 10 illustrate Scanning Electron Microscope (SEM) images of LiCoO₂ powder before applying Ca₁₀(PO₄)₆F₂ to the LiCoO₂ powder, and of LiCoO₂ powders of Examples 7 and 8 coated with Ca₁₀(PO₄)₆F₂; and

FIG. 11 illustrates results obtained by evaluating CRRs of lithium batteries of Examples 7 to 8 and Comparative Example 1.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

Reference will now be made in detail to exemplary embodiments, examples of which are illustrated in the accompanying drawings, wherein like reference numerals refer to like elements throughout. In this regard, the present exemplary embodiments may have different forms and should not be construed as being limited to the descriptions set forth herein. Accordingly, the exemplary embodiments are merely described below, by referring to the figures, to explain aspects of the present description. In the drawing figures, the dimensions of layers and regions may be exaggerated for clarity of illustration. As used herein, the term “and/or” includes any and all combinations of one or more of the associated listed items. Expressions such as “at least one of” when preceding a list of elements, modify the entire list of elements and do not modify the individual elements of the list.

Hereinafter, the present disclosure will be described more in detail.

A positive electrode active material according to one aspect of the present disclosure may have the surface of its core coated with inorganic material having an apatite structure such that the stability of the positive electrode active material may be secured at a high voltage of 4.5 V or higher. The performance of a lithium battery may also be improved.

According to one or more exemplary embodiments, the positive electrode active material may include: a core including compounds that are capable of reversibly performing intercalation or deintercalation of lithium ions; and a coating layer including inorganic material having an apatite structure adhered to at least a portion of the surface of the core.

Compounds that may be used as the core are compounds that are capable of reversibly performing intercalation or deintercalation of lithium. The compounds include those that may be used in a relevant technical field. Examples of the compounds may include: LiₐAl_{1-b}X_{b}D₂ (0.90≦a≦1.8 and 0≦b≦0.5); LiₐA_{1-b}X_{b}O_{2-c}D_{c} (0.90≦a≦1.8, 0≦b≦0.5, and 0≦c≦0.05); LiE_{2-b}X_{b}O_{4-c}D_{c} (0≦b≦0.5 and 0≦c≦0.05); LiₐNi_{1-b-c}Co_{b}X_{c}D_{α} (0.90≦a≦1.8, 0≦b≦0.5, 0≦c≦0.05, and 0<α<2); LiₐNi_{1-b-c}Co_{b}X_{c}O_{2-α}T_{α} (0.90≦a≦1.8, 0≦b≦0.5, 0≦c≦0.05, and 0<α<2); LiₐNi_{1-b-c}Co_{b}X_{c}O_{2-α}T₂ (0.90≦a≦1.8, 0≦b≦0.5, 0≦c≦0.05, and 0<α≦2); LiₐNi_{1-b-c}Mn_{b}X_{c}D_{α} (0.90≦a≦1.8, 0≦b≦0.5, 0≦c≦0.05, and 0<α≦2); LiₐNi_{1-b-c}Mn_{b}X_{c}O_{2-α}T_{α} (0.90≦a≦1.8, 0≦b≦0.5, 0≦c≦0.05, and 0<α<2); LiₐNi_{1-b-c}Mn_{b}X_{c}O_{2-aα}T₂ (0.90≦a≦1.8, 0≦b≦0.5, 0≦c≦0.05, and 0<α<2); LiₐNi_{b}E_{c}G_{d}O₂ (0.90≦a≦1.8, 0≦b≦0.9, 0≦c≦0.5, and 0.001≦d≦0.1); LiₐNi_{b}Co_{c}Mn_{d}GₑO₂ (0.90≦a≦1.8, 0≦b≦0.9, 0≦c≦0.5, 0≦d≦0.5, and 0.001≦e≦0.1); LiₐNiG_{b}O₂ (0.90≦a≦1.8 and 0.001≦b≦0.1); LiₐCoG_{b}O₂ (0.90≦a≦1.8 and 0.001≦b≦0.1); LiₐMnG_{b}O₂ (0.90≦a≦1.8 and 0.001≦b≦0.1); LiₐMn₂G_{b}O₄(0.90≦a≦1.8 and 0.001≦b≦0.1); QO₂; QS₂; LiQS₂; V₂O₅; LiV₂O₅; LiZO₂; LiNiVO₄; Li_{(3-f)}J₂(PO₄)₃(0≦f≦2); Li_{(3-f)}Fe₂(PO₄)₃(0≦f≦2); and LiFePO₄.

In the Formulas above, the letters A, X, D, S, T, G, Q, Z, and J represent variables, as further defined. For example, the letter A may be selected from Ni, Co, Mn, and combinations thereof; the letter X may be selected from Al, Ni, Co, Mn, Cr, Fe, Mg, Sr, V, rare earth elements, and combinations thereof; the letter D may be selected from O, F, S, P, and combinations thereof; the letter S may be selected from Co, Mn, and a combination thereof; the letter T may be selected from F, S, P, and combinations thereof; the letter G may be selected from Al, Cr, Mn, Fe, Mg, La, Ce, Sr, V, and combinations thereof; the letter Q may be selected from Ti, Mo, Mn, and combinations thereof; the letter Z may be selected from Cr, V, Fe, Sc, Y, and combinations thereof; and the letter J may be selected from V, Cr, Mn, Co, Ni, Cu, and combinations thereof.

For example, the core may include one or more of LiCoO₂, LiNiO₂, LiMnO₂, LiMn₂O₄, Li(NiₐCo_{b}Al_{c})O₂, Li(NiₐCo_{b}Mn_{c})O₂ (where 0<a<1, 0<b<1, 0<c<1, and a+b+c=1), LiNi_{1-Y}Co_{Y}O₂, LiCo_{1-Y}Mn_{Y}O₂, LiNi_{1-Y}Mn_{Y}O₂ (where 0≦Y≦1), Li(NiₐCo_{b}Mn_{c})O₄ (where 0<a<2, 0<b<2, 0<c<2, and a+b+c=2), Li[LiₐNi_{b}Co_{c}Mn_{d}M_{f}]O₂₋ₓFₓ (where M is one or more of Ti, V, Al, Mg, Cr, Fe, Zr, Re, Al, B, Ge, Ru, Sn, Nb, Mo or Pt, a+b+c+d+f=1; 0<a<1, 0<b<1, 0<c<1, 0<d<1, and 0<f<1; and 0≦x<0.1), LiMn_{2-z}Ni_{z}O₄, LiMn_{2-z}Co_{z}O₄ (where 0<z<2), LiCoPO₄, LiFePO₄, V₂O₅, TiS, or MoS.

The core may have an average particle diameter D50 of about 50 μm or less. For example, the core may have an average particle diameter D50 of about 1 μm to about 30 μm, about 5 μm to about 25 μm, or about 10 μm to about 20 μm.

In the present specification, the term “average particle diameter D50” refers to a cumulative average particle diameter corresponding to 50% by weight from a cumulative particle size distribution curve in which the total volume is 100%. The average particle diameter D50 may be measured by a method that is known to those skilled in the art. For example, the average particle diameter D50 may be measured by a particle size analyzer or measured from transmission electron microscope (TEM) or scanning electron microscope (SEM) photographs. For example, other methods of measuring the average particle diameter D50 may include measuring powder particle sizes of the core by a measuring device using dynamic light scattering, performing data analysis of the measured powder particle sizes of the core to count the number of particles with respect to respective particle size ranges, and performing the calculation from the counted number of particles to obtain the average particle diameter D50 easily.

The positive electrode active material may include a coating layer formed by adhering inorganic material having an apatite structure to at least a portion of the surface of such a core including compounds that are capable of reversibly performing intercalation or deintercalation of lithium ions.

According to one or more exemplary embodiments, the inorganic material having the apatite structure may be phosphate compounds represented by the following Formula 1:

Me₁₀(PO₄)₆X₂ [Formula 1]

where Me is calcium (Ca), barium (Ba), or strontium (Sr); and X is a hydroxyl group (—OH), F, or Cl.

The inorganic material having the apatite structure may have lithium ion conductivity and may conduct lithium ions through an ion exchange reaction by metal ions such as calcium ions Ca²⁺within the apatite structure. Although X is a hydroxyl group (—OH), F, or Cl, the inorganic material having the apatite structure may have lithium ion-conducting properties even through channels of the inorganic material having the apatite structure itself. The inorganic material having the apatite structure may maintain a low resistance and a high lithium ion conductivity and may secure stability at a high voltage of 4.5 V or higher and may also improve the performance of a lithium battery. A side reaction between an active material and an electrolytic solution may be controlled. The inorganic material having the apatite structure may maintain an excellent thermal stability and may be capable of improving high temperature storage characteristics of a positive electrode active material.

The inorganic material having the apatite structure may be a hydroxyapatite compound of which X is a hydroxyl group (—OH) in Formula 1. Examples of the hydroxyapatite compound may include calcium hydroxyapatite (Ca₁₀(PO₄)₆(OH)₂), barium hydroxyapatite (Ba₁₀(PO₄)₆(OH)₂), and strontium hydroxyapatite (Sr₁₀(PO₄)₆(OH)₂).

The inorganic material having the apatite structure may be a fluoroapatite compound of which X is a fluorine group (—F) in Formula 1. Examples of the fluoroapatite compound may include calcium fluoroapatite (Ca₁₀(PO₄)₆F₂), barium fluoroapatite (Ba₁₀(PO₄)₆F₂), and strontium fluoroapatite (Sr₁₀(PO₄)₆F₂).

The inorganic material having the apatite structure may be a chloroapatite compound of which X is a chlorine group (—Cl) in Formula 1. Examples of the chloroapatite compound may include calcium chloroapatite (Ca₁₀(PO₄)₆Cl₂), barium chloroapatite (Ba₁₀(PO₄)₆Cl₂), and strontium chloroapatite (Sr₁₀(PO₄)₆Cl₂).

The inorganic material having the apatite structure may be used in a single inorganic material form or in a mixed form of two or more inorganic materials.

As a coating material, particles of the inorganic material having the apatite structure having an average particle diameter D50 corresponding to, for example, one-fifth of that of the core may be evenly distributed in the core.

The inorganic material having the apatite structure may be adhered to the core in a layered structure or in an island form, wherein the term “island form” refers to, for example, a semispherical shape, a non-spherical shape, or an atypical shape having a predetermined volume, and the term “island form” refers to a shape in which a ceramic compound is discontinuously adhered to the surface of the core.

In an embodiment, the amount of an active material per unit volume of an electrode may be reduced such that the capacity of the electrode may decrease if the thickness of the coating layer is excessively thick, and an effect of suppressing a side reaction between the core and the electrolyte may be insignificant if the thickness of the coating layer is excessively thin. For example, the coating layer of the inorganic material may have a thickness of about 0.1 μm to about 10 μm.

When the inorganic material is adhered to the surface of the core in an island shape, the inorganic material may have a particle size of about 0.1 μm to about 4 μm.

Residual lithium existing in the core may be diffused during the preparation of the positive electrode active material, and the coating layer including the inorganic material having the apatite structure may additionally include lithium therein.

The above-described positive electrode active material may include the core in a content range of about 90% by weight to about 99.99% by weight and the inorganic material having the apatite structure in a content range of about 0.01% by weight to about 10% by weight. For example, the core of the above-described positive electrode active material may have a content range of about 95% by weight to about 99.9% by weight, and the inorganic material having the apatite structure thereof may have a content range of about 0.1% by weight to about 5% by weight. Maintaining the content ranges within such limits may help to effectively suppress side reactions between the core and the electrolyte. An effect of improving the lifetime characteristics of a lithium battery may be maximized.

According to one or more exemplary embodiments, the average particle diameter D50 of the positive electrode active material may be about 50 μm or less. Particle sizes of the positive electrode active material that are larger than about 50 μm may deteriorate the characteristics of the lithium battery, for example, due to increases in charging and discharging rates. For example, the average particle diameter D50 of the positive electrode active material may be about 1 μm to about 30 μm, about 5 μm to about 25 μm, or about 10 μm to about 20 μm.

Side reactions in an atmosphere of high temperatures and high voltages may be suppressed by coating the above-described positive electrode active material according to one or more exemplary embodiments of the present disclosure with the inorganic material having the apatite structure having lithium ion conductivity, and direct contact of the positive electrode active material with an electrolytic solution within a lithium battery may be prevented. Without using expensive additives, the lithium battery may secure stability and may exhibit excellent capacity and cycle characteristics in the atmosphere of high temperatures and high voltages.

A method of preparing a positive electrode active material, according to another aspect of the present disclosure, is described.

According to one or more exemplary embodiments, the method of preparing the positive electrode active material may include: mixing an inorganic material having an apatite structure with an organic solvent to prepare a coating solution; applying the coating solution to the surface of a core including a compound that is capable of reversibly performing intercalation or deintercalation of lithium ions; and heat-treating the core to which the coating solution is applied.

The inorganic material having the apatite structure may be phosphate compounds represented by the following Formula 1:

Me₁₀(PO₄)₆X₂ [Formula 1]

where Me is calcium (Ca), barium (Ba), or strontium (Sr); and X is a hydroxyl group (—OH), F, or Cl.

First, the inorganic material having the apatite structure may be uniformly dispersed into an organic solvent to prepare a coating solution. An addition amount of the inorganic material having the apatite structure may be adjusted according to a desired coating amount. A milling process such as ball milling may be performed to uniformly disperse the inorganic material into the organic solvent.

The milling process may be performed using, for example, a planetary mill, a stirred ball mill, or a vibration mill. Materials that do not react with ceramic compounds and are chemically inert may be used as beads or balls of the bead mill or the ball mill. For example, the bead mill or the ball mill may use zirconia. For example, beads of the bead mill or balls of the ball mill may have a size in the range of about 0.3 mm to about 10 mm.

Examples of the organic solvent may include ethanol, hexane, heptane, isopropanol, or N-methylpyrrolidone (NMP). For example, the settling process may be performed for about 6 hours to about 8 hours, and the inorganic material having the apatite structure may be sufficiently settled into the organic solvent.

Such a prepared coating solution may be applied to the surface of a core including compounds that are capable of reversibly performing intercalation or deintercalation of lithium.

Materials used in the core are as described above.

The coating process may be performed by a suitable coating method such as a sol-gel coating method, a spray coating method, or a dip coating method.

Next, the coating solution-coated core may be subjected to a heat-treatment process to obtain a positive electrode active material in which the inorganic material having the apatite structure is adhered to the surface of the core.

In the heat treatment process, the temperature may be increased at a temperature-increasing rate of about 0.5° C./min to about 10° C./min to help control the reaction. The increased temperature may be about 600° C. to about 1,000° C., e.g., about 600° C. to about 950° C., or about 700° C. to about 950° C. The inorganic material having the apatite structure may be heat-treated, and may be adhered to the surface of the core to help stabilize the positive electrode active material.

The core to which the inorganic material having the apatite structure is adhered may be cooled to about 200° C. to about 400° C. at a cooling rate of about 1° C./min to about 10° C./min, and may be naturally cooled thereafter.

Such a method of preparing a positive electrode active material may secure stability at high voltages, and may prepare a positive electrode active material having excellent capacity and lifetime characteristics.

A positive electrode including the above-described positive electrode active material, according to another aspect of the present disclosure, is provided, and a manufacturing process of the positive electrode will be described together with the following lithium battery manufacturing process.

A lithium battery according to another aspect of the present disclosure may include: a positive electrode including the above-described positive electrode active material; a negative electrode disposed oppositely to, e.g., opposite of, the positive electrode; and an electrolyte disposed between the positive electrode and the negative electrode.

The positive electrode may include the above-described positive electrode active material. For example, the positive electrode may be manufactured by a method of mixing the above-described positive electrode active material, a conducting agent, and a binder in a solvent to prepare a positive electrode active material composition, and molding the positive electrode active material composition into a predetermined shape or coating the positive electrode active material composition on a current collector such as copper foil.

The conducting agent used in the positive electrode active material composition may provide the positive electrode active material with a conducting path to help improve the electrical conductivity of the positive electrode active material, and conducting materials that may be used in lithium batteries may be used as the conducting agent. Examples of the conducting materials may include: carbonaceous materials such as, for example, carbon black, acetylene black, Ketjen black, and carbon fibers (e.g., vapor grown carbon fibers); metal-based materials of metal powders or metal fibers such as, for example, copper, nickel, aluminum, and silver; conductive polymers such as polyphenylene derivatives; and mixtures thereof. The conducting agent may be used by properly adjusting the amount of the conducting agent in the positive electrode active material composition. For example, the positive electrode active material and the conducting agent may be added to a weight ratio range of 99:1 to 90:10.

The binder used in the positive electrode active material composition may be added to an amount of about 1 weight part to about 50 weight parts based on 100 weight parts of the positive electrode active material as a component that helps adhesion of, for example, the positive electrode active material and the conducting agent, and adhesion with respect to the current collector. For example, the binder may be added to an amount range of 1 weight part to 30 weight parts, about 1 weight part to about 20 weight parts, or about 1 weight part to about 15 weight parts based on 100 weight parts of the positive electrode active material. Examples of such a binder may include polyvinylidene fluoride, polyvinylidene chloride, polybenzimidazole, polyimide, polyvinyl lacetate, polyacrylonitrile, polyvinyl alcohol, carboxymethyl cellulose (CMC), starch, hydroxypropyl cellulose, regenerated cellulose, polyvinyl pyrrolidone, tetrafluoroethylene, polyethylene, polypropylene, polystyrene, polymethyl methacrylate, polyaniline, acrylonitrile butadiene styrene, phenolic resin, epoxy resin, polyethylene terephthalate, polytetrafluoroethylene, polyphenylene sulfide, polyamide imide, polyetherimide, polyethylene sulfone, polyamide, polyacetal, polyphenylene oxide, polybutylene terephthalate, ethylene propylene diene terpolymer (EPDM), sulfonated EPDM, styrene butadiene rubber, fluorine rubber, or various copolymers.

Examples of the solvent may include NMP, acetone, or water. The solvent may be used in an amount range of about 1 weight part to about 100 weight parts based on 100 weight parts of the positive electrode active material. An operation of forming an active material layer may be easily performed when the solvent is used in the above-described amount range.

A current collector may be made to a thickness of about 3 μm to about 500 μm. In an embodiment, the current collector may have conductivity without causing a chemical change in a relevant battery. Examples of the current collector may include: copper, stainless steel, aluminum, nickel, titanium, calcined carbon, calcined copper, or calcined stainless steel of which the surface is treated with, for example, carbon, nickel, titanium, or silver; or an aluminum-cadmium alloy. Examples of the current collector may include: copper, stainless steel, aluminum, nickel, titanium, calcined carbon, calcined copper, or calcined stainless steel on the surface of which fine irregularities are formed to reinforce adhesion of the positive electrode active material; and various forms of films, sheets, foils, nets, porous bodies, foams, or non-woven fabrics.

The prepared positive electrode active material composition may be directly applied to the current collector to manufacture a positive electrode plate, or the positive electrode active material composition may be cast onto a separate support such that a positive electrode active material film delaminated from the support may be laminated on a copper foil current collector to obtain the positive electrode plate. In an embodiment, the positive electrode may be formed by other operations.

The positive electrode active material composition may not only be used in the manufacture of electrodes for lithium batteries, but also used in the manufacture of printable batteries with the positive electrode active material composition being printed on flexible electrode substrates.

Separately, a negative electrode active material, in which a negative electrode active material, a binder, a solvent, and selectively, a conducting agent are mixed, may be prepared to manufacture a negative electrode.

Examples of the negative electrode active material include those that may be used in the related art. Examples of the negative electrode active material may include lithium metal, metals that are capable of alloying lithium, transition metal oxides, materials that are capable of doping or dedoping lithium, and materials that are capable of reversibly performing intercalation or deintercalation of lithium ions.

Examples of the transition metal oxides may include tungsten oxides, molybdenum oxides, titanium oxides, lithium titanium oxides, vanadium oxides, and lithium vanadium oxides.

Examples of the materials that are capable of doping or dedoping lithium may include Si, SiOₓ (0<x<2), Si—Y alloy (Y may be an alkali metal, an alkali earth metal, a Group 13 element, a Group 14 element, a Group 15 element, a Group 16 element, a transition metal, a rare earth element, or a combination thereof with Y not being Si), Sn, SnO₂, Sn—Y (Y may be an alkali metal, an alkali earth metal, a Group 13 element, a Group 14 element, a Group 15 element, a Group 16 element, a transition metal, a rare earth element, or a combination thereof with Y not being Sn), or a mixture of SiO₂ and at least one thereof. Examples of the element Y may include Mg, Ca, Sr, Ba, Ra, Sc, yttrium, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, or combinations thereof.

The materials that are capable of reversibly performing intercalation or deintercalation of lithium ions include carbonaceous (negative electrode active) materials that may be used in lithium batteries. Examples of the materials that are capable of reversibly performing intercalation or deintercalation of lithium ions may include crystalline carbons, amorphous carbons, and mixtures thereof. Examples of the crystalline carbons may include: amorphous, plate-shaped, flake shaped, spherical or fibrous natural graphites; and artificial graphites. Examples of the amorphous carbons may include soft carbons (carbons calcined at low temperatures) or hard carbons, mesophase pitch carbides, and calcined cokes.

The same conducting agent, binder, and solvent as those in the above-described positive electrode active material composition may be used in a negative electrode active material composition. In some cases, a plasticizer may be additionally added to the above-described positive electrode active material composition and the negative electrode active material composition to enable the formation of pores in electrode plates. The negative electrode active material, conducting agent, binder, and solvent may be contained, e.g., provided, in amount levels that may be used in lithium batteries.

The negative electrode current collector may have a thickness of about 3 μm to about 500 μm. In an embodiment, the negative electrode current collector may have high conductivity without causing a chemical change in a relevant battery. Examples of the negative electrode current collector may include: stainless steel, aluminum, nickel, titanium, calcined carbon, calcined aluminum, or calcined stainless steel of which the surface is treated with, for example, carbon, nickel, titanium, or silver. The negative current collector may have fine irregularities formed on the surface thereof to increase adhesive strength of the negative electrode active material, and the negative current collector may be formed in various forms such as, for example, films, sheets, foils, nets, porous bodies, foams, and non-woven fabrics.

The prepared negative electrode active material composition may be directly applied to the negative electrode current collector, and the negative electrode current collector coated with the negative electrode active material composition may be dried to manufacture a negative electrode plate. In an embodiment, the negative electrode active material composition may be cast onto a separate support such that a film obtained by being delaminated from the support may be laminated on a negative electrode current collector to manufacture the negative electrode plate.

The positive electrode and the negative electrode may be separated by a separator.

Exemplary materials for the separator include materials that may be used as the separator in lithium batteries. For example, materials that have excellent electrolytic solution-containing capabilities and have low resistance values with respect to ion movements of the electrolyte may be suitable for the separator. Examples of the separator may include materials selected from glass fibers, polyester, Teflon, polyethylene, polypropylene, polytetrafluoroethylene (PTFE), or combinations thereof. The separator may be in the form of non-woven fabric or woven fabric. The separator may have a pore diameter of about 0.01 μm to about 10 μm, and may have a thickness of about 5 μm to about 300 μm.

A non-aqueous electrolyte containing lithium salts includes, e.g., consists of, a non-aqueous electrolyte and lithium salts. Examples of the non-aqueous electrolyte may include a non-aqueous electrolytic solution, an organic solid electrolyte, and an inorganic solid electrolyte.

Examples of the non-aqueous electrolytic solution may include aprotic organic solvents such as N-methyl-2-pyrrolidone, propylene carbonate, ethylene carbonate, butylenes carbonate, dimethyl carbonate, diethyl carbonate, γ-butyrolactone, 1,2-dimethoxy ethane, tetrahydrofuran, 2-methyl tetrahydrofuran, dimethyl sulfoxide, 1,3-dioxolane, formamide, dimethyl formamide, dioxolane, acetonitrile, nitromethane, methyl formate, methyl acetate, triester phosphate, trimethoxy methane, dioxolane derivatives, sulfolane, methyl sulfolane, 1,3-dimethyl-2-imidazolidinone, propylene carbonate derivatives, tetrahydrofuran derivatives, ether, methyl propionate, and ethyl propionate.

Examples of the organic solid electrolyte may include polyethylene derivatives, polyethylene oxide derivatives, polypropylene oxide derivatives, phosphate ester polymers, poly agitation lysine, polyester sulfide, polyvinyl alcohol, polyvinylidene fluoride, and polymers including dissociation groups.

Examples of the inorganic solid electrolyte may include Li nitrides, Li halides, and Li sulfates such as Li₃N, LiI, Li₅NI₂, Li₃N—LiI—LiOH, LiSiO₄, LiSiO₄—LiI—LiOH, Li₂SiS₃, Li₄SiO₄, Li₄SiO₄—LiI—LiOH, and Li₃PO₄—Li₂S—SiS₂.

Exemplary lithium salts include lithium salt that may be used in lithium batteries. Examples of the lithium salt, as a material that dissolves well in the non-aqueous electrolyte, may include one or more of LiCl, LiBr, LiI, LiClO₄, LiBF₄, LiB₁₀Cl₁₀, LiPF₆, LiCF₃SO₃, LiCF₃CO₂, LiAsF₆, LiSbF₆, LiAlCl₄, CH₃SO₃Li, CF₃SO₃Li, (CF₃SO₂)₂NLi, lithium chloroborate, lower aliphatic lithium carbonate, or 4-phenyllithium boric acid, lithium imide.

The lithium batteries may be classified as lithium ions batteries, lithium ion polymer batteries, and lithium polymer batteries depending on the types of the separator and the electrolyte used. The lithium batteries may be classified as, for example, cylindrical lithium batteries, rectangular lithium batteries, coin-type lithium batteries, and pouch-type lithium batteries, depending on shapes of the lithium batteries. The lithium batteries may be d classified as bulk-type lithium batteries and thin film-type lithium batteries depending on sizes of the lithium batteries. The lithium batteries may be classified as lithium secondary batteries as well as lithium primary batteries.

These batteries may be manufactured by suitable methods.

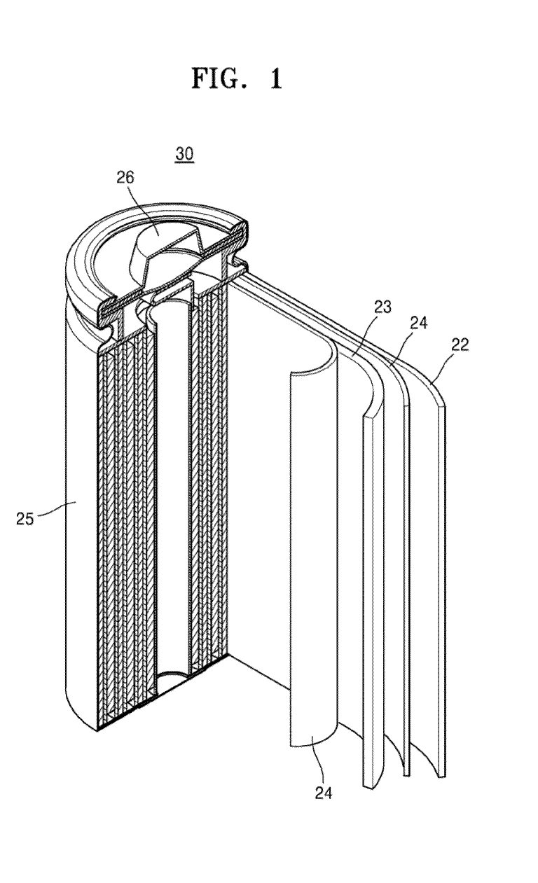

FIG. 1 illustrates a representative structure of a lithium battery 30 according to one or more exemplary embodiments of the present disclosure.

Referring to FIG. 1, the lithium battery 30 may include a positive electrode 23, a negative electrode 22, and a separator 24 disposed between the positive electrode 23 and the negative electrode 22. The positive electrode 23, the negative electrode 22, and the separator 24 may be wound or folded and housed in a battery container 25. Subsequently, an electrolyte may be injected into the battery container 25, and the battery container 25 may be sealed by a sealing member 26, and the forming of the lithium battery 30 may be completed. The battery container 25 may be formed in, for example, a cylindrical shape, a rectangular shape, or a thin film-type shape. The lithium battery 30 may be a lithium ion battery.

The lithium batteries may be used not only as batteries used as power sources of small devices such as, for example, cellular phones and portable computers, but also as unit batteries in battery modules of medium to large sized devices including multiple batteries.

Examples of the medium to large sized devices may include: power tools; xEV including electric vehicles (EV), hybrid electric vehicles (HEV), and plug-in hybrid electric vehicles (PHEV); electric two-wheeled vehicles including E-bikes and E-scooters; electric golf carts; electric trucks; electric commercial vehicles; and power storage systems. The lithium batteries may be used in other applications requiring high output power, high voltage, and high temperature driving. The lithium batteries may be used in uses requiring a high voltage range of about 4.3 V to about 4.6 V.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

### Example 1

### (1) Preparation of Ca₁₀(PO₄)₆(OH)₂

Ca₁₀(PO₄)₆(OH)₂ was synthesized by the following Formula using Ca(OH)₂ and H₃PO₄:

10Ca(OH)₂+6H₃PO₄→Ca₁₀(PO₄)₆(OH)₂+18H₂O

Since Ca/P of Ca₁₀(PO₄)₆(OH)₂ has a mole ratio of about 1.6667, a precipitate was formed by dissolving 10 g (0.135 mol) of Ca(OH)₂ into 275 ml (0.491 M) of distilled water to prepare a Ca(OH)₂ solution, dissolving 7.935 g (0.081 mol) of H₃PO₄ into 270 ml (0.299 M) of distilled water to prepare an H₃PO₄ solution, and injecting the H₃PO₄ solution into the Ca(01-1)₂ solution. After filtering the precipitate and drying the filtered precipitate at about 80° C., the dried precipitate was calcined at about 1,000° C. to synthesize Ca₁₀(PO₄)₆(OH)₂.

### (2) Preparation of LiCoO₂ (LCO) coated with Ca₁₀(PO₄)₆(OH)₂

0.01 g of the synthesized Ca₁₀(PO₄)₆(OH)₂ was added to 10 ml of ethanol, and the synthesized Ca₁₀(PO₄)₆(OH)₂ was precipitated in ethanol for about 7 hours to prepare a Ca₁₀(PO₄)₆(OH)₂ coating solution. Then, 10 g of LiCoO₂ was added to the coating solution. After heating Ca₁₀(PO₄)₆(OH)₂ and LiCoO₂ to about 80° C. in the presence of ethanol such that ethanol was volatilized, LiCoO₂ was collected and heated to about 950° C. at a temperature increasing rate of about 5° C./min, and the heated LiCoO₂ was calcined at about 950° C. for about 5 hours to prepare a positive electrode active material in which 0.1% by weight of Ca₁₀(PO₄)₆(OH)₂ was applied to the surface of LiCoO₂.

### (3) Manufacturing of a Lithium Battery

About 94% by weight of the positive electrode active material prepared in the above-described process, about 3% by weight of carbon black as a conducting agent, and about 3% by weight of polyvinylidene fluoride (PVDF) as a binder were dispersed into N-methyl-2-pyrrolidone (NMP) to prepare a positive electrode slurry. The positive electrode slurry was applied to an aluminum (Al) thin film having a thickness of about 20 μm to about 30 μm as a positive electrode current collector. The positive electrode slurry applied to the Al thin film was dried, and a roll press process was performed on the dried positive electrode slurry applied to the Al thin film to manufacture a positive electrode.

Metal lithium was used as a counter electrode with respect to the positive electrode, and an electrolytic solution was prepared by adding about 1.1 M of LiPF₆ in a solvent in which ethylene carbonate (EC), ethylmethyl carbonate (EMC) and dimethyl carbonate (DMC) were mixed to a volume ratio of 3:5:2.

A lithium battery (a 2016 type coin half cell) was manufactured by interposing a separator that was a porous polyethylene (PE) film between the positive electrode and the negative electrode to form a battery assembly, coiling and compressing the battery assembly such that the coiled and compressed battery assembly was put into a battery case, and injecting the electrolytic solution into the battery case containing the battery assembly.

### Example 2

A positive electrode active material and a lithium battery were manufactured by performing the same process as in Example 1 except that a Ca₁₀(PO₄)₆(OH)₂ coating solution, in which 0.025 g of Ca₁₀(PO₄)₆(OH)₂ was added to 10 ml of ethanol, was used to prepare a positive electrode active material in which 0.025% by weight of Ca₁₀(PO₄)₆(OH)₂ was applied to the surface of LiCoO₂.

### Example 3

A positive electrode active material and a lithium battery were manufactured by performing the same process as in Example 1 except that a Ca₁₀(PO₄)₆(OH)₂ coating solution, in which 0.05 g of Ca₁₀(PO₄)₆(OH)₂ was added to 10 ml of ethanol, was used to prepare a positive electrode active material in which 0.5% by weight of Ca₁₀(PO₄)₆(OH)₂ was applied to the surface of LiCoO₂.

### Example 4

A positive electrode active material and a lithium battery were manufactured by performing the same process as in Example 1 except that a Ca₁₀(PO₄)₆(OH)₂ coating solution, in which 0.1 g of Ca₁₀(PO₄)₆(OH)₂ was added to 40 ml of ethanol, was used to prepare a positive electrode active material in which 1% by weight of Ca₁₀(PO₄)₆(OH)₂ was applied to the surface of LiCoO₂.

### Example 5

A positive electrode active material and a lithium battery were manufactured by performing the same process as in Example 1 except that a Ca₁₀(PO₄)₆(OH)₂ coating solution, in which 0.3 g of Ca₁₀(PO₄)₆(OH)₂ was added to 100 ml of ethanol, was used to prepare a positive electrode active material in which 3% by weight of Ca₁₀(PO₄)₆(OH)₂ was applied to the surface of LiCoO₂.

### Example 6

A positive electrode active material and a lithium battery were manufactured by performing the same process as in Example 1 except that a Ca₁₀(PO₄)₆(OH)₂ coating solution, in which 0.5 g of Ca₁₀(PO₄)₆(OH)₂ was added to 100 ml of ethanol, was used to prepare a positive electrode active material in which 5% by weight of Ca₁₀(PO₄)₆(OH)₂ was applied to the surface of LiCoO₂.

### Example 7

### (1) Preparation of LiCoO₂ (LCO) Coated with Ca₁₀(PO₄)₆F₂

A positive electrode active material was prepared by performing the same process as in (2) of Example 1 except that a Ca₁₀(PO₄)₆F₂ coating solution, in which 0.05 g of Ca₁₀(PO₄)₆F₂ (produced by Sigma-Aldrich Corporation) was added to 20 ml of ethanol, was used to prepare a positive electrode active material in which 0.5% by weight of Ca₁₀(PO₄)₆F₂ was applied to the surface of LiCoO₂.

### (2) Manufacturing of a Lithium Battery

A lithium battery was manufactured by the same process as in (3) of Example 1.

### Example 8

A positive electrode active material and a lithium battery were manufactured by performing the same process as in Example 7 except that a Ca₁₀(PO₄)₆(OH)₂ coating solution, in which 0.75 g of Ca₁₀(PO₄)₆(OH)₂ was added to 60 ml of ethanol, was used to prepare a positive electrode active material in which 1.5% by weight of Ca₁₀(PO₄)₆F₂ was applied to the surface of LiCoO₂.

### Comparative Example 1

A lithium battery was manufactured by performing the same process as in Example 1 except that uncoated LiCoO₂ was used as a positive electrode active material.

### Evaluation Example 1

### XRD Analysis of Ca₁₀(PO₄)₆(OH)₂ Coating

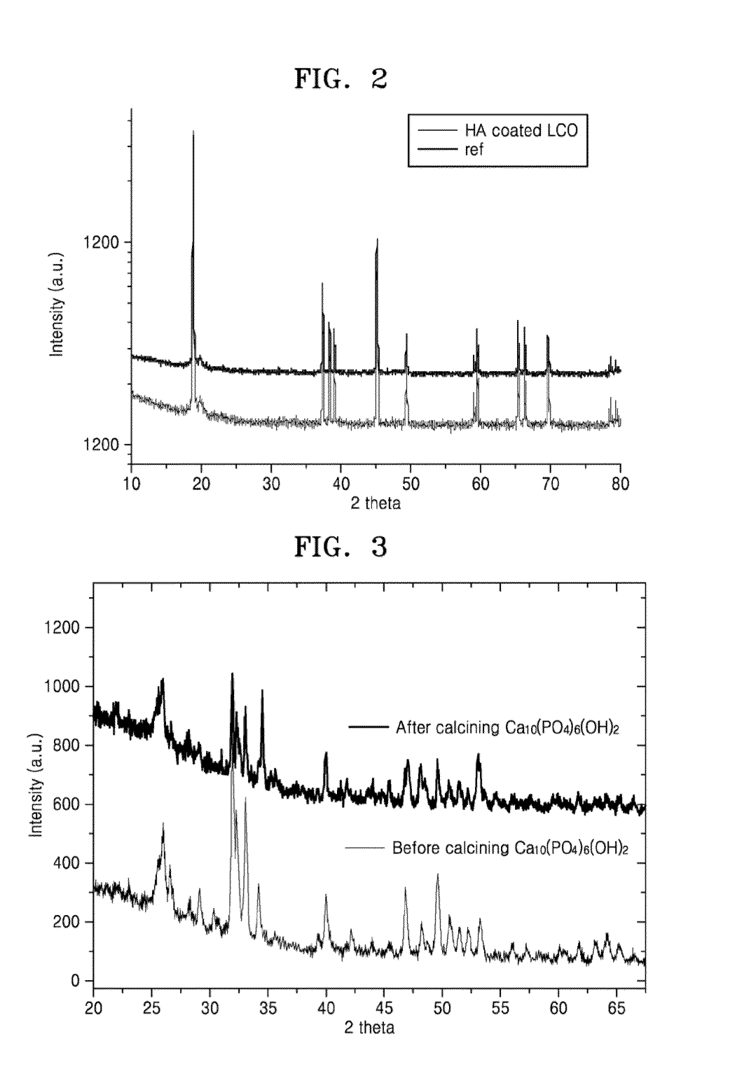

X-ray diffraction (XRD) analysis results on the positive electrode active material (“ref”) and the Ca₁₀(PO₄)₆(OH)₂-coated positive electrode active material (“HA coated LCO”) using an X-ray diffraction system, X'pert PRO MPD, manufactured by PANalytical Inc., before and after coating Ca₁₀(PO₄)₆(OH)₂ on the positive electrode active material prepared in Example 1, are represented in FIG. 2. An experimental condition was a characteristic X-ray of CuK alpha at a wavelength of 1.541 Å.

As shown in FIG. 2, in the positive electrode active material prepared in Example 1, peaks on Ca₁₀(PO₄)₆(OH)₂ having a hydroxyapatite structure formed on the surface of LCO (“HA coated LCO”) and LCO (“ref”) peaks were not well distinguished since the peaks on Ca₁₀(PO₄)₆(OH)₂ had relatively low strength values.

To confirm whether the coating material Ca₁₀(PO₄)₆(OH)₂ was maintained in a Ca₁₀(PO₄)₆(OH)₂ phase even after the coating material Ca₁₀(PO₄)₆(OH)₂ used in Example 1 was calcined at about 950° C., a calcination process was separately performed at about 950° C. on Ca₁₀(PO₄)₆(OH)₂ synthesized in (1) of Example 1, XRD analysis was performed on the synthesized Ca₁₀(PO₄)₆(OH)₂ and the calcined synthesized Ca₁₀(PO₄)₆(OH)₂, and the XRD analysis results are represented in FIG. 3.

As shown in FIG. 3, phases are maintained in XRD results of the coating material Ca₁₀(PO₄)₆(OH)₂ even after calcining the coating material Ca₁₀(PO₄)₆(OH)₂. It was confirmed that the XRD results conformed to other XRD results of a Ca₁₀(PO₄)₆(OH)₂ phase.

### Evaluation Example 2

### Evaluation of Battery Characteristics During Coating of Ca₁₀(PO₄)₆(OH)₂

Constant-current charging was performed on the lithium batteries manufactured in Examples 1 to 6 and Comparative Example 1 at about 25° C. and a current of about 0.1 C rate until a voltage of about 4.6 V (vs. Li) was reached, and discharging was performed on the constant-current charged lithium batteries at a constant current of about 0.1 C until a voltage of about 3 V (vs. Li) during discharging (chemical conversion step) was reached.

A cycle was repeated 50 times, wherein the cycle included performing constant-current charging on the lithium batteries subjected to the chemical conversion step at about 25° C. and a current of about 1 C rate until a voltage of about 4.6 V (vs. Li) was reached and performing discharging on the constant-current charged lithium batteries at a constant current of about 1 C until a voltage of about 3 V (vs. Li) during discharging was reached.

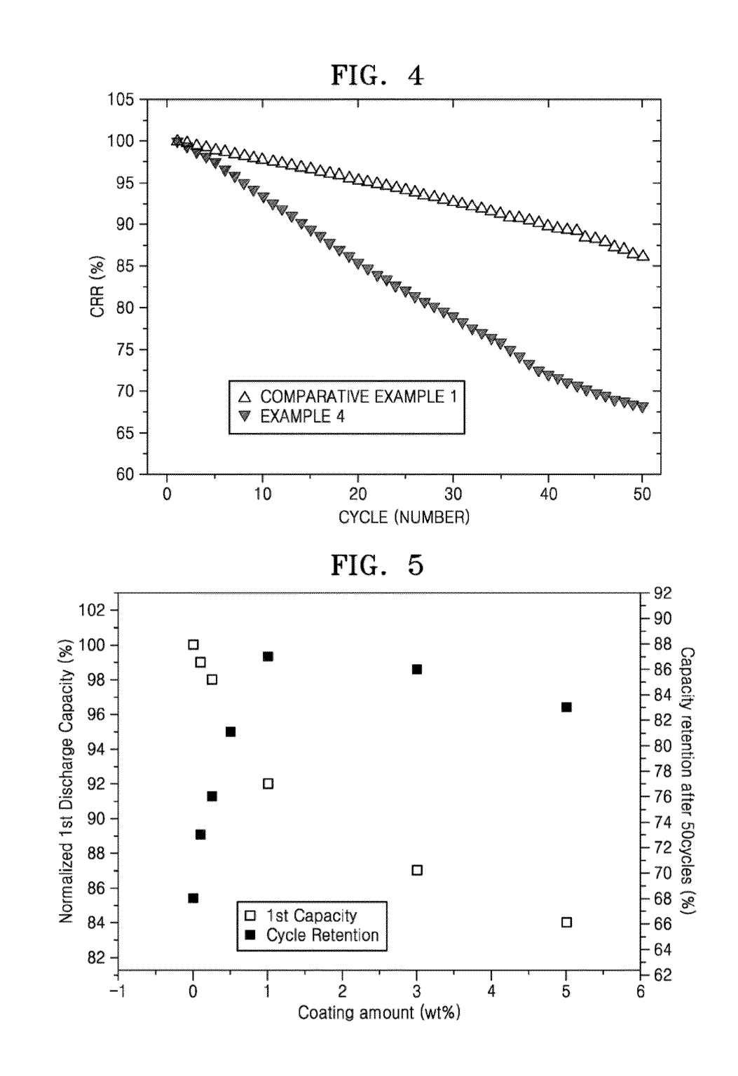

Capacity retention ratios of the lithium batteries of Example 4 and Comparative Example 1 are represented in FIG. 4. The capacity retention ratio is defined by the following Equation 1:

Capacity retention ratio [%]=[discharge capacity at each cycle/discharge capacity at first cycle]×100 <Equation 1>

As shown in FIG. 4, lifetime characteristics at a high voltage were substantially improved in Ca₁₀(PO₄)₆(OH)₂-coated LCO (Example 4), compared to Ca₁₀(PO₄)₆(OH)₂-noncoated LCO (Comparative Example 1).

To check lifetime characteristics and normalized first discharge capacity per coating amount, initial efficiencies and capacity retention ratios after 50 cycles of lithium batteries of Examples 1 to 6 and Comparative Example 1 are represented in FIG. 5. The normalized first discharge capacity is defined as a ratio of a first discharge capacity per coating amount to an uncoated LCO's first discharge capacity (i.e., 180 mA/g) as represented by the following Equation 2:

Normalized first discharge capacity [%]=[discharge capacity at the first cycle per coating amount/uncoated LCO's discharge capacity at the first cycle]×100 <Equation 2>

As shown in FIG. 5, although an increase in the coating amount was accompanied by a decrease in capacity, the lifetime characteristics were maximally increased when the coating amount was 1% by weight and the increased lifetime characteristics were maintained to some degree until the coating amount was 5% by weight.

### Evaluation Example 3

### XRD Analysis of Ca₁₀(PO₄)₆F₂ Coating

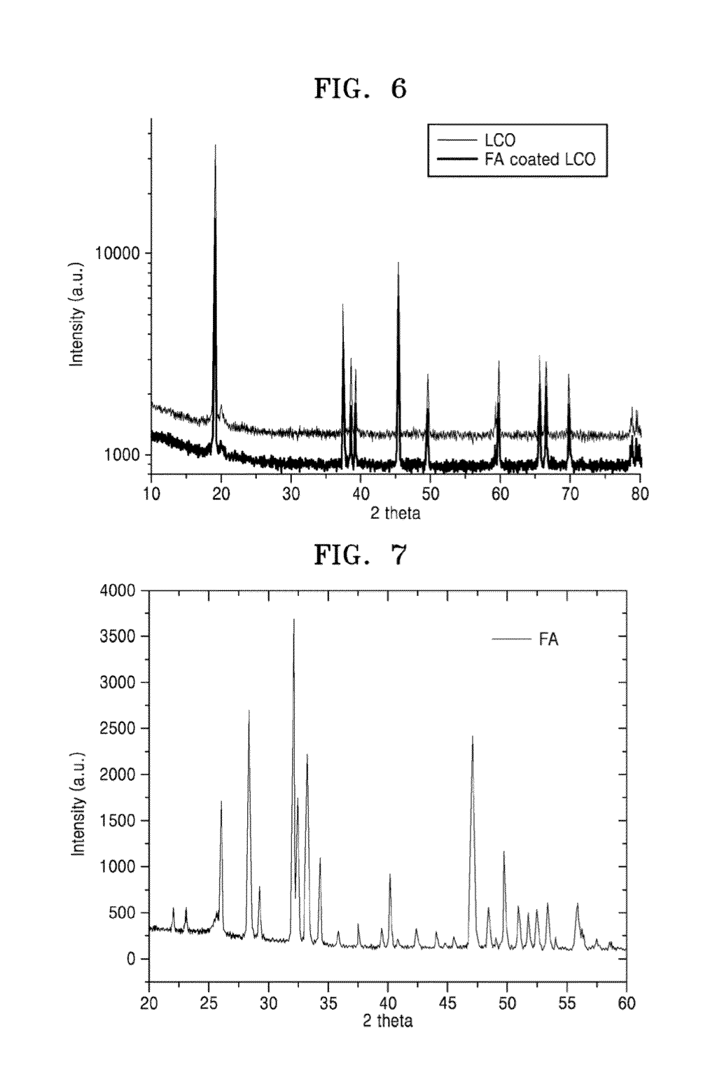

XRD analysis results on the positive electrode active material (“LCO” and the Ca₁₀(PO₄)₆F₂-coated positive electrode active material (“FA coated LCO”) using an X-ray diffraction system, X'pert PRO MPD, manufactured by PANalytical Inc., before and after coating Ca₁₀(PO₄)₆F₂ on the positive electrode active material prepared in Example 7, are represented in FIG. 6. An experimental condition was a characteristic X-ray of CuK alpha at a wavelength of 1.541 Å.

As shown in FIG. 6, in the positive electrode active material prepared in Example 7, peaks on Ca₁₀(PO₄)₆F₂ having a fluoroapatite structure formed on the surface of LCO (“FA coated LCO”) and LCO (“LCO”) peaks were not well distinguished since the peaks on Ca₁₀(PO₄)₆F₂ had relatively low strength values.

To confirm whether the coating material Ca₁₀(PO₄)₆F₂ was maintained in a Ca₁₀(PO₄)₆F₂ phase even after the coating material Ca₁₀(PO₄)₆F₂ used in Example 1 was calcined at about 950° C., a calcination process was separately performed at about 950° C. on Ca₁₀(PO₄)₆F₂ used in Example 7, XRD analysis was performed on the calcined Ca₁₀(PO₄)₆F₂, and the XRD analysis results are represented in FIG. 7.

As shown in FIG. 7, it was confirmed that XRD results of the calcined coating material Ca₁₀(PO₄)₆F₂ after calcination (“FA”) conform to those of Ca₁₀(PO₄)₆F₂ of [JCPDS No. 15-0876].

### Evaluation Example 4

### Checking the Coating State of Ca₁₀(PO₄)₆F₂

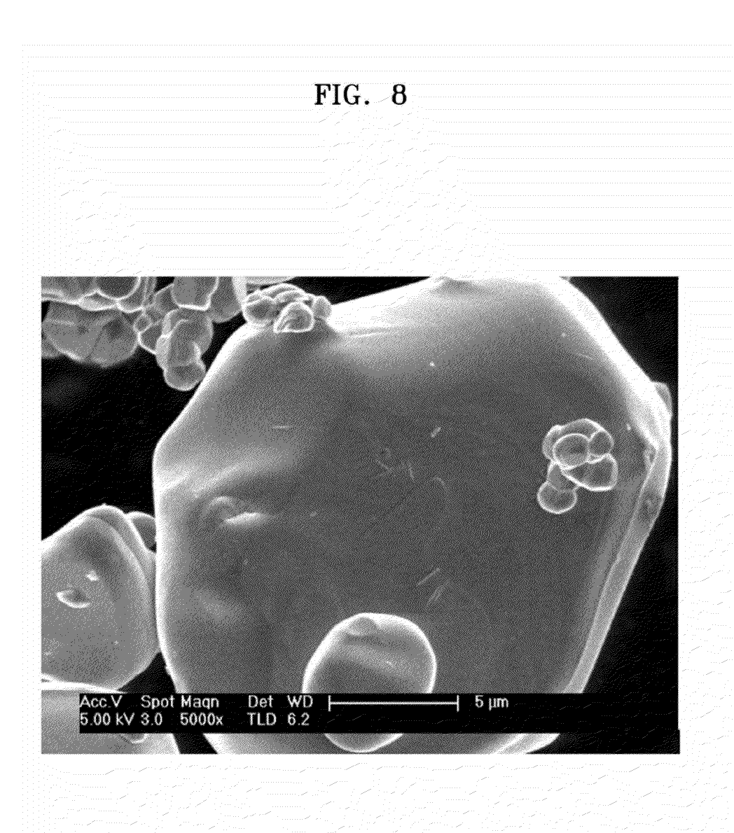

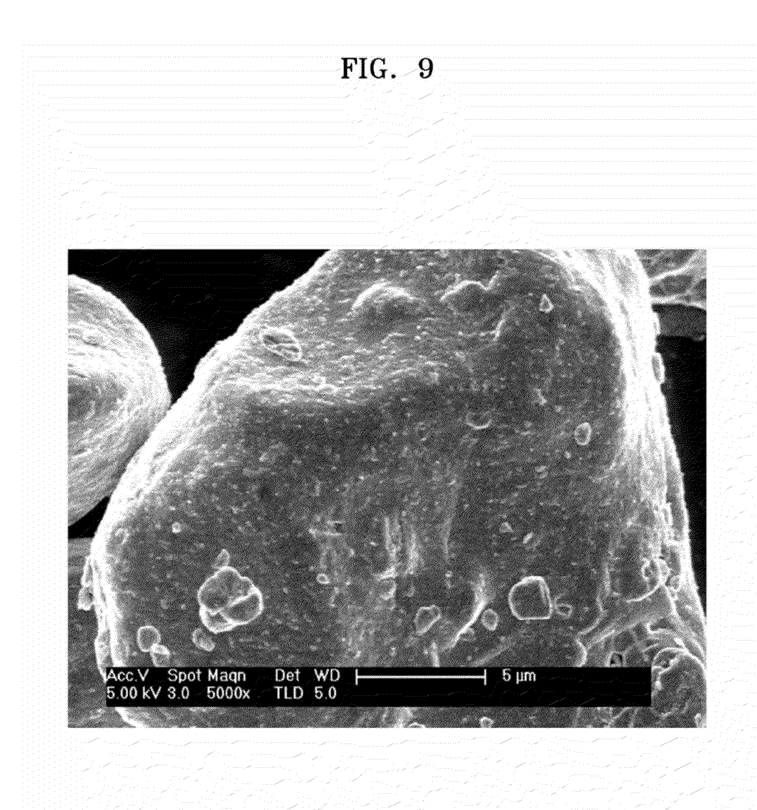

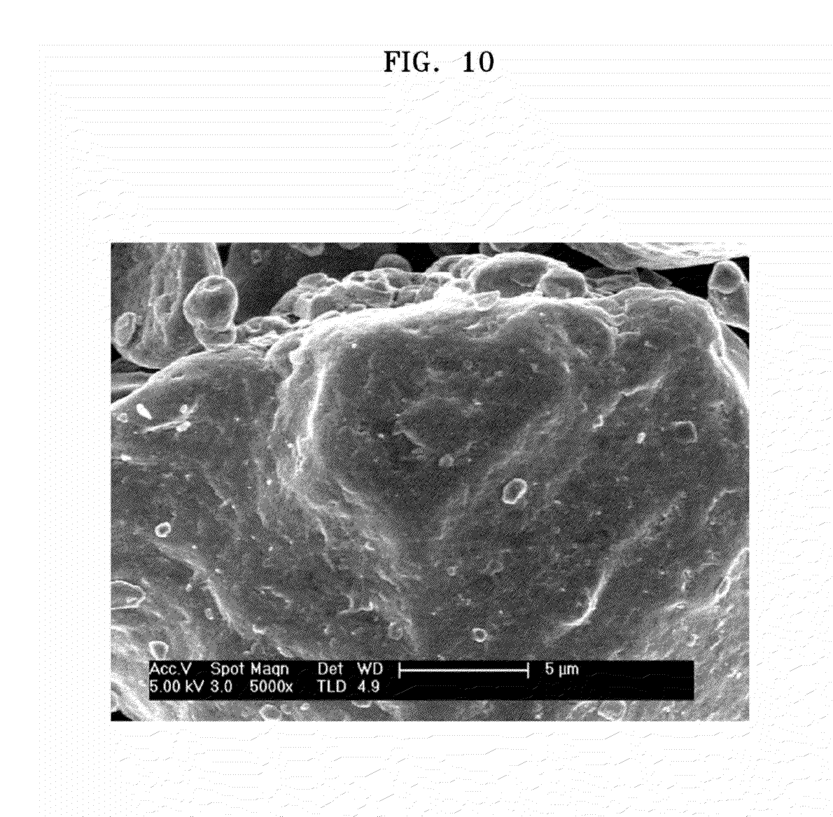

FIGS. 8 to 10 illustrate Scanning Electron Microscope (SEM) images of LiCoO₂ powder before applying Ca₁₀(PO₄)₆F₂ to the LiCoO₂ powder, and of LiCoO₂ powders of Examples 7 and 8 coated with Ca₁₀(PO₄)₆F₂.

As shown in FIGS. 8 to 10, Ca₁₀(PO₄)₆F₂ particles were formed on the surface of LiCoO₂ powder in an island shape after performing the coating process on the positive electrode active materials prepared in Examples 7 and 8.

### Evaluation Example 5

### Evaluation of Battery Characteristics During Coating of Ca₁₀(PO₄)₆F₂

Constant-current charging was performed on the lithium batteries manufactured in Examples 7 to 8 and Comparative Example 1 at about 25° C. and a current of about 0.1 C rate until a voltage of about 4.55 V (vs. Li) was reached, and discharging was performed on the constant-current charged lithium batteries at a constant current of about 0.1 C until a voltage of about 3 V (vs. Li) during discharging (chemical conversion step) was reached.

A cycle was repeated 40 times, wherein the cycle included performing constant-current charging on the lithium batteries subjected to the chemical conversion step at about 25° C. and a current of about 1 C rate until a voltage of about 4.55 V (vs. Li) was reached and performing discharging on the constant-current charged lithium batteries at a constant current of about 1 C until a voltage of about 3 V (vs. Li) during discharging was reached.

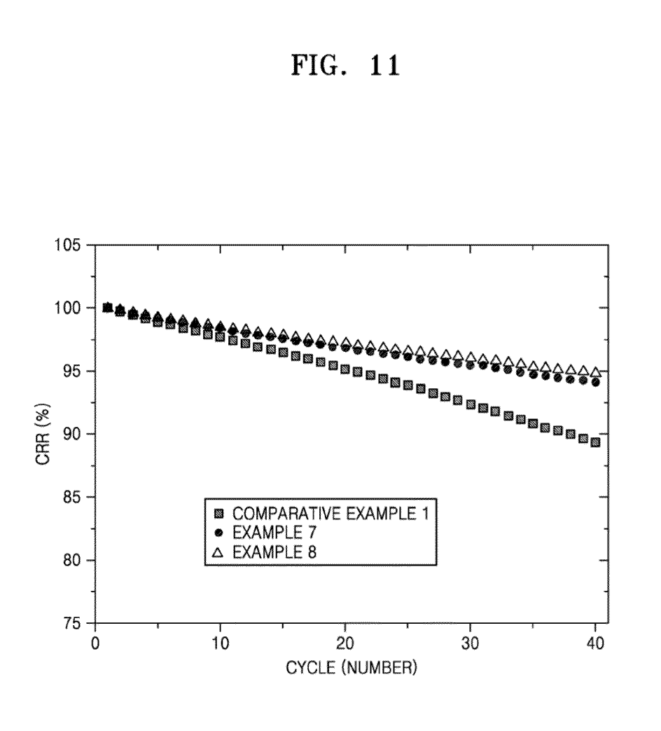

Capacity retention ratios of the lithium batteries of Examples 7 to 8 and Comparative Example 1 are represented in FIG. 11. As shown in FIG. 11, lifetime characteristics at a high voltage were improved in Ca₁₀(PO₄)₆F₂-coated LCO (Examples 7 to 8), compared to Ca₁₀(PO₄)₆F₂-noncoated LCO (Comparative Example 1).

### Evaluation Example 6

### Evaluating High-Temperature Storage Characteristics

Constant-current charging was performed on the lithium batteries manufactured in Examples 7 to 8 and Comparative Example 1 at about 45° C. and a current of about 0.2 C rate until a voltage of about 4.55 V (vs. Li) was reached, and discharging (0.2 D) was performed on the constant-current charged lithium batteries at a constant current of about 0.2 C until a voltage of about 3 V (vs. Li) during discharging (chemical conversion step) was reached (“First Cycle”).

After holding the lithium batteries subjected to the chemical conversion step at about 60° C. for one week, constant-current charging was performed on the lithium batteries at about 45° C. and a current of about 0.2 C rate until a voltage of about 4.55 V (vs. Li) was reached (“Third Cycle”), and discharging (0.2 D) was performed on the constant-current charged lithium batteries at the same current of about 0.2 C rate (“Fourth Cycle”).

Initial efficiencies, capacity retention ratios at the third cycle, and recovery capacities at the fourth cycle of the lithium batteries manufactured in Examples 7 to 8 and Comparative Example 1 are represented in the following Table 1:

TABLE 1

| | First Cycle (45° C.) | | | Third Cycle (45° C.) | | | | | | |
|---|---|---|---|---|---|---|---|---|---|---|
| | | | Initial | | After | | | Fourth Cycle (45° C.) | | |
| | | | Coulombic | | Storage | Retention | | | Recovery | |
| Sample | 0.2 C | 0.2 D | Efficiency | 0.2 C | (V) | (mAh/g) | Retention | 0.2 D | (mAh/g) | Recovery |
| Comparative | 224 | 215 | 96% | 218 | | 136 | 63% | 185 | 180 | 84% |
| Example 1 | | | | | | | | | | |
| Example 7 | 216 | 214 | 99% | 214 | 4.223 | 140 | 65% | 189 | 189 | 88% |
| | 217 | 214 | 99% | 215 | 4.225 | 141 | 66% | 191 | 189 | 88% |
| Example 8 | 213 | 211 | 99% | 211 | 4.221 | 139 | 66% | 190 | 189 | 90% |
| | 215 | 213 | 99% | 213 | 4.219 | 140 | 66% | 191 | 190 | 89% |

As shown in Table 1, not only initial charge efficiencies were improved, but also recovery capacities as well as capacity retention ratios were improved in Ca₁₀(PO₄)₆F₂-coated LCO (Examples 7 to 8), compared to Ca₁₀(PO₄)₆F₂-noncoated LCO (Comparative Example 1).

By way of summation and review, lithium secondary batteries used in electric vehicles, electric bicycles, and portable electric devices for information and communication such as Personal Digital Assistants (PDAs), cellular phones, and laptop computers may have discharge voltages equal to or greater than twice the discharge voltages of comparative batteries, and may exhibit high energy densities.

Lithium secondary batteries may be reused by repeating charging and discharging thereof and may produce electrical energy by oxidation and reduction reactions when lithium ions are intercalated into positive and negative electrodes or deintercalated from the positive and negative electrodes in a state that an organic electrolytic solution or a polymer electrolytic solution is charged between positive and negative electrodes including active materials enabling intercalation or deintercalation of lithium ions.

Characteristics of lithium secondary batteries include, for example, capacities, lifetime cycles, and safety, and characteristics such as operating voltages and capacities of the secondary batteries may be determined according to active materials used in the electrodes. Such characteristics may be related to thermodynamic stabilities of the active materials. Other chemical reactions may take place according to types of binders, electrolytic solution compositions, interactions of the electrolytic solutions and active materials, and types of the active materials. The chemical environments of the electrodes may vary, for example, due to additional chemical reactions that may take place according to elements constituting the batteries, and such characteristics may be confirmed only after constructing the batteries.

Although LiCoO₂ may be doped or coated with dissimilar metallic materials such that the stabilities of the active materials themselves may be improved, capacity deteriorations, for example, due to cycles may be exhibited since side reactions with the electrolytic solution at high temperatures and high voltages, e.g., 4.5 V or higher, may be more severe than a reaction at room temperature when LiCoO₂ is applied to batteries. Although spinel materials may show good characteristics at 5 V and room temperature such that the stabilities of the active materials may be secured, applying spinel materials to batteries may be difficult, for example, due to high temperature characteristics and Mn eluting problems.

One or more exemplary embodiments include positive electrode active materials that may reduce side reactions, for example, due to interactions with an electrolytic solution in specific atmospheres, and may be capable of improving the capacities and lifetime characteristics of lithium batteries at high voltages, e.g., 4.5 V or higher. One or more exemplary embodiments include lithium batteries including the positive electrode active materials. One or more exemplary embodiments include methods of preparing the positive electrode active materials.

As described above, according to one or more of the above exemplary embodiments, a positive electrode active material may be coated with inorganic material having an apatite structure, stability of the positive electrode active material at a high voltage may be secured, and capacities and lifetime characteristics of lithium batteries may be improved.

Example embodiments have been disclosed herein, and although specific terms are employed, they are used and are to be interpreted in a generic and descriptive sense only and not for purpose of limitation. In some instances, as would be apparent to one of skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A positive electrode active material, comprising:
a core including a compound capable of reversibly performing intercalation or deintercalation of lithium ions; and
a coating layer including an inorganic material adhered to at least a portion of a surface of the core, the inorganic material having an apatite structure.

2. The positive electrode active material as claimed in claim 1, wherein the inorganic material having the apatite structure is represented by the following Formula 1:
Me₁₀(PO₄)₆X₂ [Formula 1]
where Me is calcium (Ca), barium (Ba), or strontium (Sr); and X is a hydroxyl group (—OH), F, or Cl.

3. The positive electrode active material as claimed in claim 1, wherein the inorganic material having the apatite structure includes one or more of calcium hydroxyapatite (Ca₁₀(PO₄)₆(OH)₂), barium hydroxyapatite (Ba₁₀(PO₄)₆(OH)₂), strontium hydroxyapatite (Sr₁₀(PO₄)₆(OH)₂), calcium fluoroapatite (Ca₁₀(PO₄)₆F₂), barium fluoroapatite (Ba₁₀(PO₄)₆F₂), strontium fluoroapatite (Sr₁₀(PO₄)₆F₂), calcium chloroapatite (Ca₁₀(PO₄)₆Cl₂), barium chloroapatite (Ba₁₀(PO₄)₆Cl₂), or strontium chloroapatite (Sr₁₀(PO₄)₆Cl₂).

4. The positive electrode active material as claimed in claim 1, wherein the inorganic material having the apatite structure is adhered to the surface of the core in a layered form or an island form.

5. The positive electrode active material as claimed in claim 1, wherein the coating layer further includes lithium.

6. The positive electrode active material as claimed in claim 1, wherein the positive electrode active material includes about 90% by weight to about 99.99% by weight of the core and about 0.01% by weight to about 10% by weight of the inorganic material having the apatite structure.

7. The positive electrode active material as claimed in claim 1, wherein the positive electrode active material includes about 95% by weight to about 99.9% by weight of the core and about 0.01% by weight to about 5% by weight of the inorganic material having the apatite structure.

8. The positive electrode active material as claimed in claim 1, wherein the core includes one or more of LiCoO₂, LiNiO₂, LiMnO₂, LiMn₂O₄, Li(NiₐCo_{b}Al_{c})O₂, Li(NiₐCo_{b}Mn_{c})O₂ (where 0<a<1, 0<b<1, 0<c<1, and a+b+c=1), LiNi_{1-Y}Co_{Y}O₂, LiCo_{1-Y}Mn_{Y}O₂, LiNi_{1-Y}Mn_{Y}O₂ (where 0≦Y<1), Li(NiₐCo_{b}Mn_{c})O₄ (where 0<a<2, 0<b<2, 0<c<2, and a+b+c=2), Li[LiₐNi_{b}Co_{c}Mn_{d}M_{f}]O₂₋ₓFₓ (where M is one or more of Ti, V, Al, Mg, Cr, Fe, Zr, Re, Al, B, Ge, Ru, Sn, Nb, Mo, or Pt; a+b+c+d+f=1; 0<a<1, 0<b<1, 0<c<1, 0<d<1, and 0<f<1; and 0≦x<0.1), LiMn_{2-z}Ni_{z}O₄, LiMn_{2-z}Co_{z}O₄ (where 0<Z<2), LiCoPO₄, LiFePO₄, V₂O₅, TiS, or MoS.

9. A lithium battery, comprising:
a positive electrode including the positive electrode active material as claimed in claim 1;
a negative electrode opposite of the positive electrode; and
an electrolyte between the positive electrode and the negative electrode.

10. The lithium battery as claimed in claim 9, wherein the lithium battery is operated in a voltage range of about 4.3 V to about 4.6 V.

11. A method of preparing a positive electrode active material, the method comprising:
mixing an inorganic material having an apatite structure with an organic solvent to prepare a coating solution;
applying the coating solution to a surface of a core, the core including a compound capable of reversibly performing intercalation or deintercalation of lithium ions; and
heat-treating the core to which the coating solution is applied.

12. The method of preparing the positive electrode active material as claimed in claim 11, wherein the inorganic material having the apatite structure is represented by the following Formula 1:
Me₁₀(PO₄)₆X₂ [Formula 1]
where Me is calcium (Ca), barium (Ba), or strontium (Sr); and X is a hydroxyl group (—OH), F, or Cl.

13. The method of preparing the positive electrode active material as claimed in claim 11, wherein heat-treating the core to which the coating solution is applied is performed at a temperature of about 600° C. to about 1,000° C. for about 3 hours to about 10 hours.
